(19) United States
(12) Patent Application Publication
(10) Pub. No.: US 2023/0153782 A1
(43) Pub. Date: May 18, 2023

(54) METHOD AND SYSTEM FOR TRACKING SOLICITATIONS FOR CONTRIBUTORY PAYMENTS FOR COMMERCIAL TRANSACTIONS

(71) Applicant: JPMorgan Chase Bank, N.A., New York, NY (US)

(72) Inventors: Scott HANSEN, Jersey City, NJ (US); Christopher J. LEASOR, Fair Haven, NJ (US); Adithya SAIRAMACHANDRAN, Troy, MI (US); Ajithkumar R. NAIR, Bridgewater, NJ (US)

(73) Assignee: JPMorgan Chase Bank, N.A., New York, NY (US)

(21) Appl. No.: 17/984,451

(22) Filed: Nov. 10, 2022

Related U.S. Application Data
(60) Provisional application No. 63/264,049, filed on Nov. 15, 2021.

(51) Int. Cl. G06Q 20/22; G06Q 20/14

(52) U.S. Cl. CPC G06Q 20/22; G06Q 20/14

(57) ABSTRACT

Method and systems for tracking a solicitation of contributory payments from multiple parties in connection with a commercial transaction, such as a restaurant bill, by using an application that is trained by using a machine learning technique are provided. The method includes: receiving a notification that a transaction has been executed by a user; obtaining information that relates to the transaction; generating, based on the received information, a recommendation for soliciting contributions from potential participants with respect to the transaction; receiving information that relates to the potential participants; and receiving a confirmation of the recommendation. The generation of the recommendation may be implemented by applying a machine learning algorithm that is trained by using historical transaction data and/or data that relates to a merchant and/or a type of merchandise involved in the transaction.

### CROSS-REFERENCE TO RELATED APPLICATIONS

This application claims priority benefit from U.S. Provisional Application No. 63/264,049, filed Nov. 15, 2021, which is hereby incorporated by reference in its entirety.

### BACKGROUND

### 1. Field of the Disclosure

This technology generally relates to methods and systems for tracking a solicitation of contributory payments from multiple parties in connection with a commercial transaction, such as a restaurant bill, by using an application that is trained by using a machine learning technique.

### 2. Background Information

For some types of commercial transactions, there may a circumstance by which a single bill or invoice is generated but multiple parties intend to pay a portion of the total amount. For example, when a group of two or more persons enjoys a meal together at a restaurant, typically there will be a single bill, but often separate parties will contribute toward payment of the bill.

There are several conventional ways to make payments and/or contribute toward payment of a bill, such as, for example, the use of cash or the use of a payment card, such as a charge card, a credit card, or a debit card. However, many find it more convenient to use a smart phone application to make payments electronically with the need for cash or a payment card. In addition, in a circumstance in which there is a single bill with multiple parties contributing payments, there is also an issue regarding how to divide the total payment amount equitably among the parties.

Accordingly, there is a need for a method for tracking a solicitation of contributory payments from multiple parties in connection with a commercial transaction, such as a restaurant bill, by using an application that is trained by using a machine learning technique.

### SUMMARY

The present disclosure, through one or more of its various aspects, embodiments, and/or specific features or sub-components, provides, inter alia, various systems, servers, devices, methods, media, programs, and platforms for methods and systems for tracking a solicitation of contributory payments from multiple parties in connection with a commercial transaction, such as a restaurant bill, by using an application that is trained by using a machine learning technique.

According to an aspect of the present disclosure, a method for tracking a solicitation of contributory payments from multiple parties in connection with a single transaction is provided. The method is implemented by at least one processor. The method includes: receiving, by the at least one processor, a notification that the single transaction has been executed by a user; obtaining, by the at least one processor, first information that relates to the transaction; generating, by the at least one processor based on the first information, a recommendation for soliciting contributions from a plurality of potential participants with respect to the transaction; transmitting, by the at least one processor to the user, the recommendation; receiving, by the at least one processor from the user, second information that relates to the plurality of potential participants; and receiving, by the at least one processor, a confirmation of the recommendation.

The first information may include at least one from among a total payment amount of the transaction and an identification of a merchant that relates to the transaction.

The second information may include at least one from among a number of potential participants, an identification of at least one of the potential participants, and an instruction that relates to a respective requested payment amount for each respective one of the potential participants.

The instruction that relates to the respective requested payment amount may include an indication that each respective requested payment amount is equal.

Alternatively, the instruction that relates to the respective requested payment amount may include an indication that the respective requested payment amounts are customized so as to vary among the potential participants.

The method may further include: retrieving historical transaction data that relates to the user; using the retrieved historical transaction data to train a machine learning algorithm to be used for generating the recommendation; and generating the recommendation by applying the machine learning algorithm to the received first information.

When the identification of the merchant includes a restaurant, the generating of the recommendation may further include using historical information that relates to the restaurant as an input to the machine learning algorithm.

The historical information that relates to the restaurant may include at least one from among first information that relates to coffee, second information that relates to hamburgers, third information that relates to sandwiches, fourth information that relates to chicken, fifth information that relates to pizza, sixth information that relates to Asian cuisine, seventh information that relates to beverages, eighth information that relates to Mexican cuisine, ninth information that relates to Mediterranean cuisine, tenth information that relates to American cuisine, eleventh information that relates to Brazilian cuisine, and twelfth information that relates to high-end cuisine.

The historical information that relates to the restaurant may further include at least one Gaussian curve that relates to an expected cost of an outing at the restaurant.

According to another exemplary embodiment, a computing apparatus for tracking a solicitation of contributory payments from multiple parties in connection with a single transaction is provided. The computing apparatus includes a processor; a memory; and a communication interface coupled to each of the processor and the memory. The computing apparatus may further include a display that is also coupled to the communication interface. The processor is configured to: receive, via the communication interface, a notification that the single transaction has been executed by a user; obtain first information that relates to the transaction; generate, based on the first information, a recommendation for soliciting contributions from a plurality of potential participants with respect to the transaction; transmit, to the user via the communication interface, the recommendation; receive, from the user via the communication interface, second information that relates to the plurality of potential participants; and receive, via the communication interface, a confirmation of the recommendation.

The first information may include at least one from among a total payment amount of the transaction and an identification of a merchant that relates to the transaction.

The second information may include at least one from among a number of potential participants, an identification of at least one of the potential participants, and an instruction that relates to a respective requested payment amount for each respective one of the potential participants.

The instruction that relates to the respective requested payment amount may include an indication that each respective requested payment amount is equal.

Alternatively, the instruction that relates to the respective requested payment amount may include an indication that the respective requested payment amounts are customized so as to vary among the potential participants.

The processor may be further configured to: retrieve historical transaction data that relates to the user; use the retrieved historical transaction data to train a machine learning algorithm to be used for generating the recommendation; and generate the recommendation by applying the machine learning algorithm to the received first information.

When the identification of the merchant includes a restaurant, the processor may be further configured to generate the recommendation by using historical information that relates to the restaurant as an input to the machine learning algorithm.

The historical information that relates to the restaurant may include at least one from among first information that relates to coffee, second information that relates to hamburgers, third information that relates to sandwiches, fourth information that relates to chicken, fifth information that relates to pizza, sixth information that relates to Asian cuisine, seventh information that relates to beverages, eighth information that relates to Mexican cuisine, ninth information that relates to Mediterranean cuisine, tenth information that relates to American cuisine, eleventh information that relates to Brazilian cuisine, and twelfth information that relates to high-end cuisine.

The historical information that relates to the restaurant may further include at least one Gaussian curve that relates to an expected cost of an outing at the restaurant.

According to yet another exemplary embodiment, a non-transitory computer readable storage medium storing instructions for tracking a solicitation of contributory payments from multiple parties in connection with a single transaction is provided. The storage medium includes executable code which, when executed by a processor, causes the processor to: receive a notification that the single transaction has been executed by a user; obtain first information that relates to the transaction; generate, based on the first information, a recommendation for soliciting contributions from a plurality of potential participants with respect to the transaction; transmit, to the user, the recommendation; receive, from the user, second information that relates to the plurality of potential participants; and receive a confirmation of the recommendation.

The first information may include at least one from among a total payment amount of the transaction and an identification of a merchant that relates to the transaction.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for tracking a solicitation of contributory payments from multiple parties in connection with a commercial transaction, such as a restaurant bill, by using an application that is trained by using a machine learning technique.

FIG. 4 is a flowchart of an exemplary process for implementing a method for tracking a solicitation of contributory payments from multiple parties in connection with a commercial transaction, such as a restaurant bill, by using an application that is trained by using a machine learning technique.

FIG. 5 is a first screen shot of a user interface for a smart phone application that executes a method for tracking a solicitation of contributory payments from multiple parties in connection with a commercial transaction, such as a restaurant bill, according to an exemplary embodiment.

FIG. 6 is a second screen shot of a user interface for a smart phone application that executes a method for tracking a solicitation of contributory payments from multiple parties in connection with a commercial transaction, such as a restaurant bill, according to an exemplary embodiment.

FIG. 7 is a third screen shot of a user interface for a smart phone application that executes a method for tracking a solicitation of contributory payments from multiple parties in connection with a commercial transaction, such as a restaurant bill, according to an exemplary embodiment.

FIG. 8 is a fourth screen shot of a user interface for a smart phone application that executes a method for tracking a solicitation of contributory payments from multiple parties in connection with a commercial transaction, such as a restaurant bill, according to an exemplary embodiment.

FIG. 9 is a fifth screen shot of a user interface for a smart phone application that executes a method for tracking a solicitation of contributory payments from multiple parties in connection with a commercial transaction, such as a restaurant bill, according to an exemplary embodiment.

FIG. 10 is a sixth screen shot of a user interface for a smart phone application that executes a method for tracking a solicitation of contributory payments from multiple parties in connection with a commercial transaction, such as a restaurant bill, according to an exemplary embodiment.

FIG. 11 is a seventh screen shot of a user interface for a smart phone application that executes a method for tracking a solicitation of contributory payments from multiple parties in connection with a commercial transaction, such as a restaurant bill, according to an exemplary embodiment.

FIG. 12 is an eighth screen shot of a user interface for a smart phone application that executes a method for tracking a solicitation of contributory payments from multiple parties in connection with a commercial transaction, such as a restaurant bill, according to an exemplary embodiment.

FIG. 13 is a ninth screen shot of a user interface for a smart phone application that executes a method for tracking a solicitation of contributory payments from multiple parties in connection with a commercial transaction, such as a restaurant bill, according to an exemplary embodiment.

FIG. 14 is a tenth screen shot of a user interface for a smart phone application that executes a method for tracking a solicitation of contributory payments from multiple parties in connection with a commercial transaction, such as a restaurant bill, according to an exemplary embodiment.

FIG. 15 is an eleventh screen shot of a user interface for a smart phone application that executes a method for tracking a solicitation of contributory payments from multiple parties in connection with a commercial transaction, such as a restaurant bill, according to an exemplary embodiment.

FIG. 16 is a twelfth screen shot of a user interface for a smart phone application that executes a method for tracking a solicitation of contributory payments from multiple parties in connection with a commercial transaction, such as a restaurant bill, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

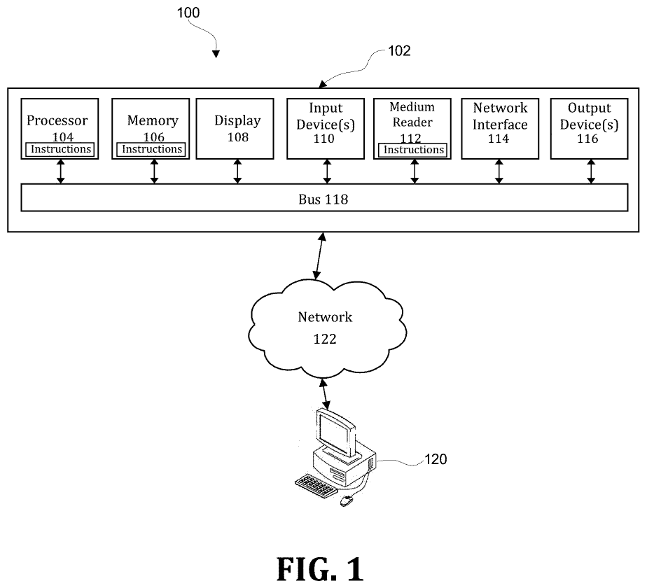

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device such as a smart phone, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for tracking a solicitation of contributory payments from multiple parties in connection with a commercial transaction, such as a restaurant bill, by using an application that is trained by using a machine learning technique.

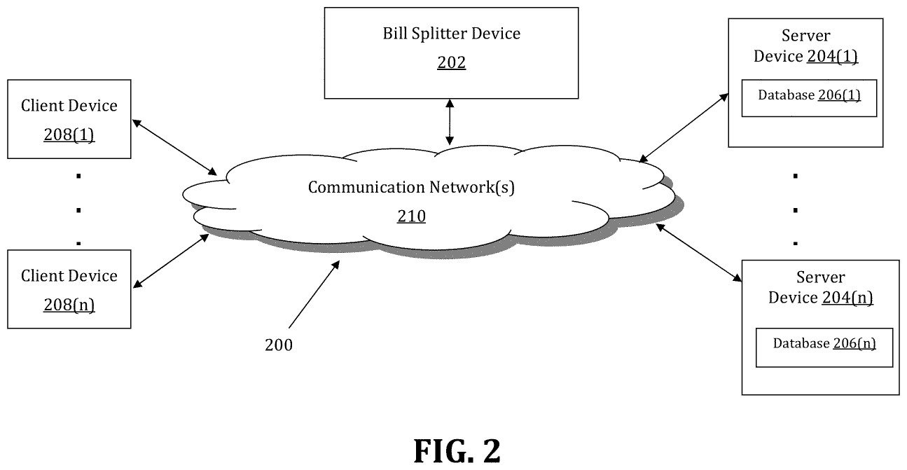

Referring to FIG. 2, a schematic of an exemplary network environment 200 for implementing a method for tracking a solicitation of contributory payments from multiple parties in connection with a commercial transaction, such as a restaurant bill, by using an application that is trained by using a machine learning technique is illustrated. In an exemplary embodiment, the method is executable on any networked computer platform, such as, for example, a personal computer (PC), a tablet computer, or a smart phone.

The method for tracking a solicitation of contributory payments from multiple parties in connection with a commercial transaction, such as a restaurant bill, by using an application that is trained by using a machine learning technique may be implemented by a Bill Splitter device 202. The Bill Splitter device 202 may be the same or similar to the computer system 102 as described with respect to FIG. 1. The Bill Splitter device 202 may store one or more applications that can include executable instructions that, when executed by the Bill Splitter device 202, cause the Bill Splitter device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the Bill Splitter device 202 itself, may be located in virtual server(s) running in a cloud-based computing environment rather than being tied to one or more specific physical network computing devices. Also, the application(s) may be running in one or more virtual machines (VMs) executing on the Bill Splitter device 202. Additionally, in one or more embodiments of this technology, virtual machine(s) running on the Bill Splitter device 202 may be managed or supervised by a hypervisor.

In the network environment 200 of FIG. 2, the Bill Splitter device 202 is coupled to a plurality of server devices 204(1)-204(n) that hosts a plurality of databases 206(1)-206(n), and also to a plurality of client devices 208(1)-208(n) via communication network(s) 210. A communication interface of the Bill Splitter device 202, such as the network interface 114 of the computer system 102 of FIG. 1, operatively couples and communicates between the Bill Splitter device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the Bill Splitter device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and Bill Splitter devices that efficiently implement a method for tracking a solicitation of contributory payments from multiple parties in connection with a commercial transaction, such as a restaurant bill, by using an application that is trained by using a machine learning technique.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The Bill Splitter device 202 may be a standalone device or integrated with one or more other devices or apparatuses, such as one or more of the server devices 204(1)-204(n), for example. In one particular example, the Bill Splitter device 202 may include or be hosted by one of the server devices 204(1)-204(n), and other arrangements are also possible. Moreover, one or more of the devices of the Bill Splitter device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the Bill Splitter device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to individual payor accounts and transaction histories and information that relates to categories of commercial entities, such as food and drink establishments.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the Bill Splitter device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the Bill Splitter device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the Bill Splitter device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the Bill Splitter device 202, the server devices 204(1)-204(n), or the client devices 208(1)-208(n), for example, may be configured to operate as virtual instances on the same physical machine. In other words, one or more of the Bill Splitter device 202, the server devices 204(1)-204(n), or the client devices 208(1)-208(n) may operate on the same physical device rather than as separate devices communicating through communication network(s) 210. Additionally, there may be more or fewer Bill Splitter devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

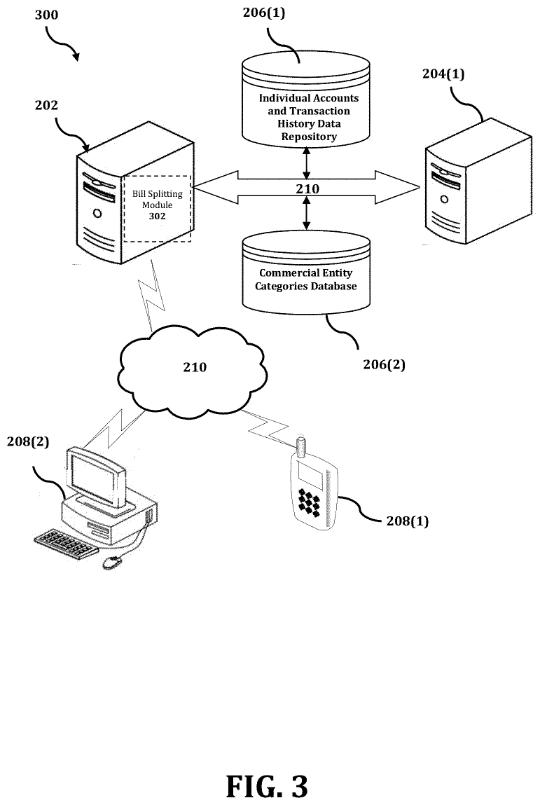

The Bill Splitter device 202 is described and illustrated in FIG. 3 as including a bill splitting module 302, although it may include other rules, policies, modules, databases, or applications, for example. As will be described below, the bill splitting module 302 is configured to implement a method for tracking a solicitation of contributory payments from multiple parties in connection with a commercial transaction, such as a restaurant bill, by using an application that is trained by using a machine learning technique.

An exemplary process 300 for implementing a mechanism for tracking a solicitation of contributory payments from multiple parties in connection with a commercial transaction, such as a restaurant bill, by using an application that is trained by using a machine learning technique by utilizing the network environment of FIG. 2 is illustrated as being executed in FIG. 3. Specifically, a first client device 208(1) and a second client device 208(2) are illustrated as being in communication with Bill Splitter device 202. In this regard, the first client device 208(1) and the second client device 208(2) may be “clients” of the Bill Splitter device 202 and are described herein as such. Nevertheless, it is to be known and understood that the first client device 208(1) and/or the second client device 208(2) need not necessarily be “clients” of the Bill Splitter device 202, or any entity described in association therewith herein. Any additional or alternative relationship may exist between either or both of the first client device 208(1) and the second client device 208(2) and the Bill Splitter device 202, or no relationship may exist.

Further, Bill Splitter device 202 is illustrated as being able to access an individual accounts and transaction history data repository 206(1) and a commercial entity categories database 206(2). The bill splitting module 302 may be configured to access these databases for implementing a method for tracking a solicitation of contributory payments from multiple parties in connection with a commercial transaction, such as a restaurant bill, by using an application that is trained by using a machine learning technique.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the Bill Splitter device 202 via broadband or cellular communication. Of course, these embodiments are merely exemplary and are not limiting or exhaustive.

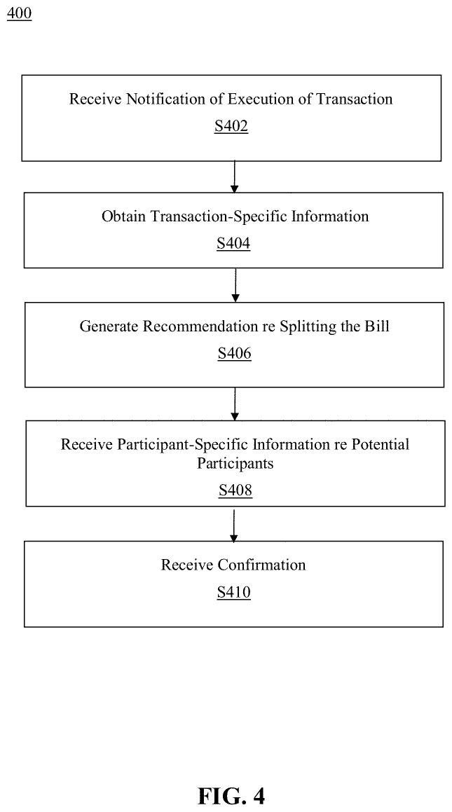

Upon being started, the bill splitting module 302 executes a process for tracking a solicitation of contributory payments from multiple parties in connection with a commercial transaction, such as a restaurant bill, by using an application that is trained by using a machine learning technique. An exemplary process for tracking a solicitation of contributory payments from multiple parties for a commercial transaction, such as a restaurant bill, by using an application that is trained by using a machine learning technique is generally indicated at flowchart 400 in FIG. 4.

In process 400 of FIG. 4, at step S402, the bill splitting module 302 receives a notification that a commercial transaction has been executed by a user, i.e., a payor. In an exemplary embodiment, the payor may desire to obtain contributions from other potential payors. In this aspect, an opportunity for conducting such a transaction may occur when a group visits a restaurant to dine out together. The user may be an account holder with a financial institution, such as a bank, that is operating the bill splitting module 302.

At step S404, the bill splitting module 302 obtains transaction-specific information. In an exemplary embodiment, the transaction-specific information may include a total payment amount of the transaction and an identification of a merchant that is participating in the transaction.

At step S406, the bill splitting module 302 generates a recommendation regarding splitting the bill among a group of potential participants, and then transmits the recommendation to the user. In an exemplary embodiment, the bill splitting module 302 applies a machine learning algorithm to the received information items (i.e., the transaction-specific information obtained in step S404) in order to generate the recommendation. The machine learning algorithm may be trained by using historical transaction data that pertains to the account that is associated with the user, which data may be retrieved from the individual accounts and transaction history data repository 206(1).

The recommendation may also be partly based on information that is retrieved from the commercial entity categories database 206(2). For example, when the merchant is a restaurant, the commercial entity categories database 206(2) may include data for a food-and-drink category that includes various genres of food and drink, such as any one or more of the following: coffee; burgers; sandwiches; chicken; pizza; Asian cuisine; drinks; Mexican cuisine; Mediterranean cuisine; American cuisine; Brazilian cuisine; and high-end cuisine. In addition, the commercial entity categories database 206(2) may also include a set of Gaussian curves (i.e., “bell” curves or normal distributions) that relate to average amounts that an individual diner may expect to pay for an outing at such an establishment. Thus, the machine learning algorithm may use this data as an input for generating the recommendation. As another example, the merchant may include an airline that offers travel-related services, a hotel or other establishment that offers lodging services, and/or any other suitable type of merchant for which splitting a cost of services provided to more than one customer may be contemplated.

At step S408, the bill splitting module 302 may receive information that relates to the potential participants. In an exemplary embodiment, the bill splitting module 302 may prompt the user to provide information about the potential participants, and the user may respond by entering information as a user input. The information may include, for example, a number of potential participants, an identification of one or more of the potential participants, and an instruction that relates to a respective requested payment amount for each respective potential participant. In an exemplary embodiment, the instruction for the payment amounts may indicate an equal split of the bill, or customized amounts that vary from individual to individual.

At step S410, the bill splitting module 302 receives a confirmation from the user with respect to the recommendation.

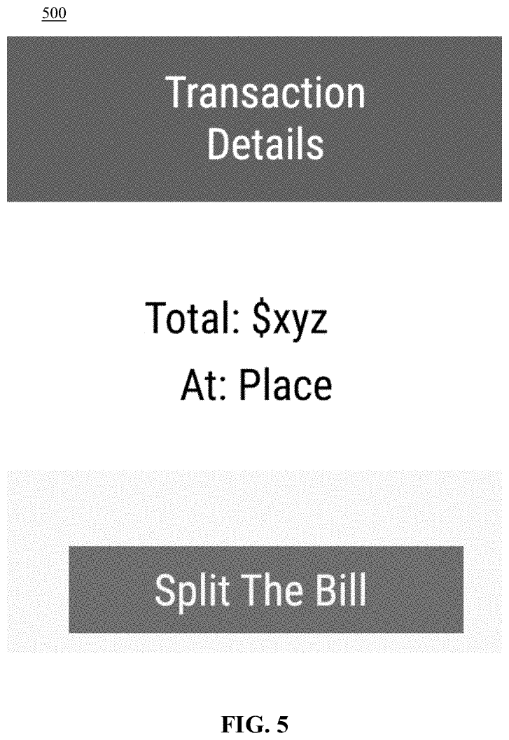

FIGS. 5-12 are screen shots 500, 600, 700, 800, 900, 1000, 1100, 1200, 1300, 1400, 1500, and 1600 of a user interface for a smart phone application that executes a method for tracking a solicitation of contributory payments from multiple parties in connection with a commercial transaction, such as a restaurant bill, according to an exemplary embodiment.

When a user desires to conduct a single transaction that involves obtaining payments from multiple parties, the user may use his/her smart phone to access a smart phone application (hereinafter referred to as “app”) that executes a method for tracking a solicitation of contributory payments from multiple parties in connnection a commercial transaction, such as a restaurant bill, according to an exemplary embodiment. Referring to FIG. 5, in such a scenario, the user may initially see a user interface that includes a first screen shot 500, which identifies the app as a “Split the Bill” app and also provides a heading “Transaction Details”, a total amount for the proposed transaction, and an identification of a place and/or a commercial establishment that identifies the proposed recipient of the total payment for the transaction.

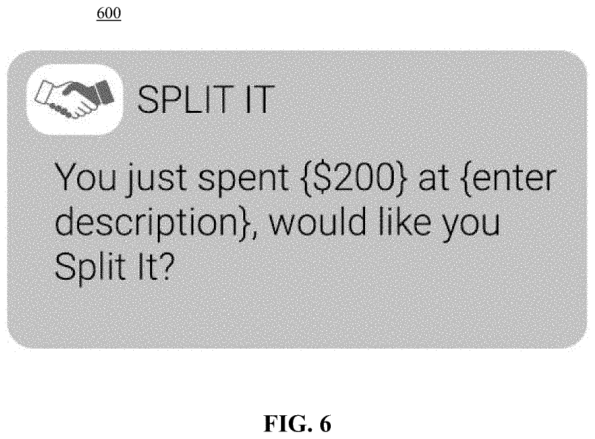

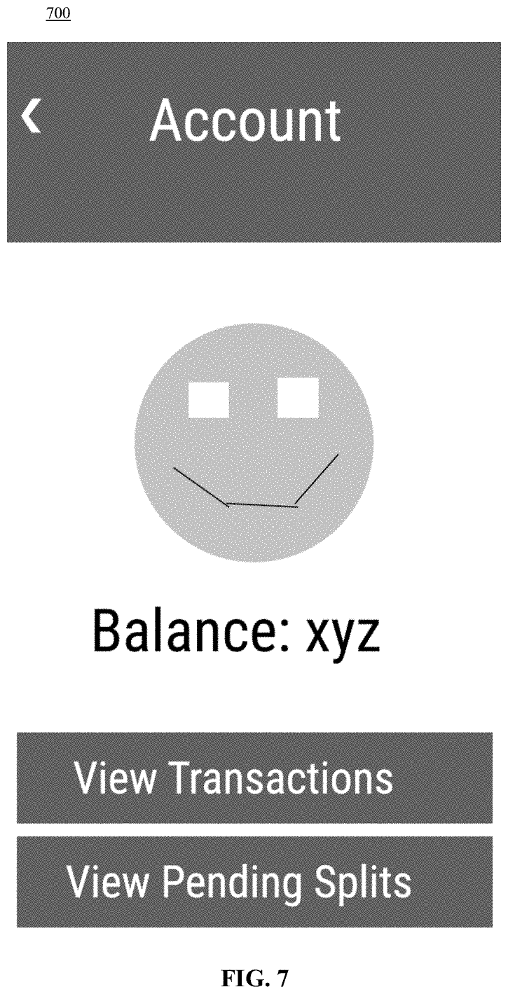

Referring to FIG. 6, a second screen shot 600 includes a message that prompts the user to indicate whether he/she wishes to split the bill, as displayed on the user interface of the smart phone. Then, when the user responds affirmatively, referring to FIG. 7, a third screen shot 700 displays, on the user interface, an account header, an account balance, and buttons that enable the user to view transactions and/or to view pending transaction splits.

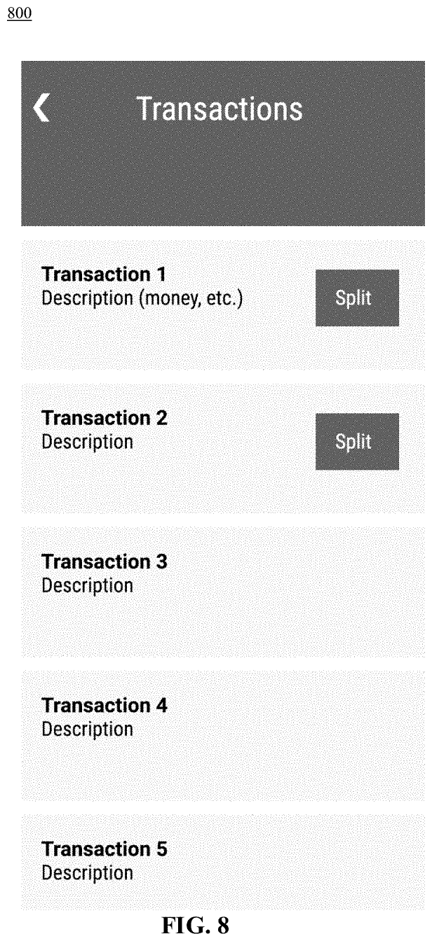

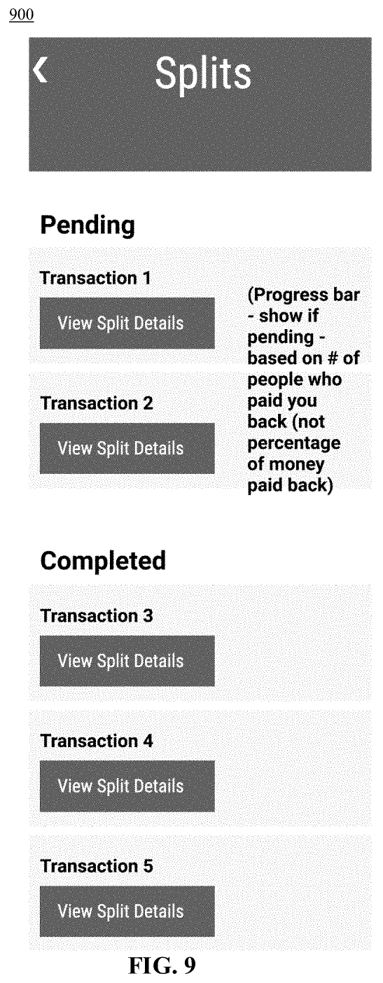

Referring to FIG. 8, a fourth screen shot 800 includes a list of transactions that is displayed on the user interface when the user clicks on the “View Transactions” button shown in FIG. 7. The list of transactions includes a description of each listed transaction and, in some cases, a button labeled “Split” that invites the user to initiate a split of the corresponding transaction. Referring to FIG. 9, a fifth screen shot 900 includes a list of split transactions that is displayed on the user interface when the user clicks on the “View Pending Splits” button shown in FIG. 7. The list of split transactions includes a list of pending split transactions and a list of completed split transactions, and in both lists, each transaction is accompanied by a button labeled “View Split Details” that invites the user to view specific details that relate to the corresponding split transaction.

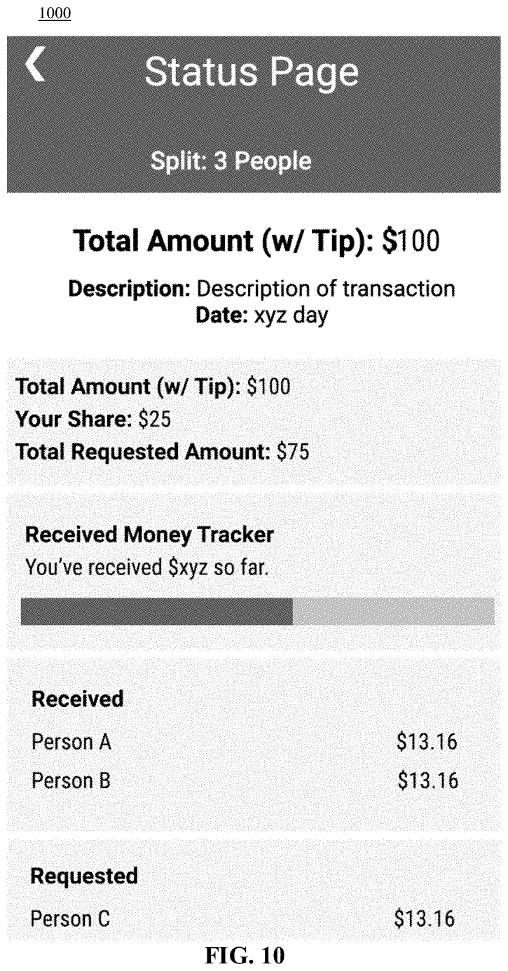

Referring to FIG. 10, a sixth screen shot 1000 shows a status page that includes various details for a particular split transaction, which may be displayed on the user interface in response to the user having clicked on a “View Split Details” button as illustrated in FIG. 9. The displayed information includes a number of participants (i.e., “Split: 3 People”; a total amount with gratuity (i.e., “Total Amount (w/Tip): $100)”; a description of the transaction; a date of the transaction; an amount of the user's share of the total amount; a requested amount from other participants; a received money tracker that indicates an amount that has been received from other participants thus far; and a breakdown of each participant that indicates a respective amount for each and a status re whether each amount has been received already or whether each amount has been requested but not yet received.

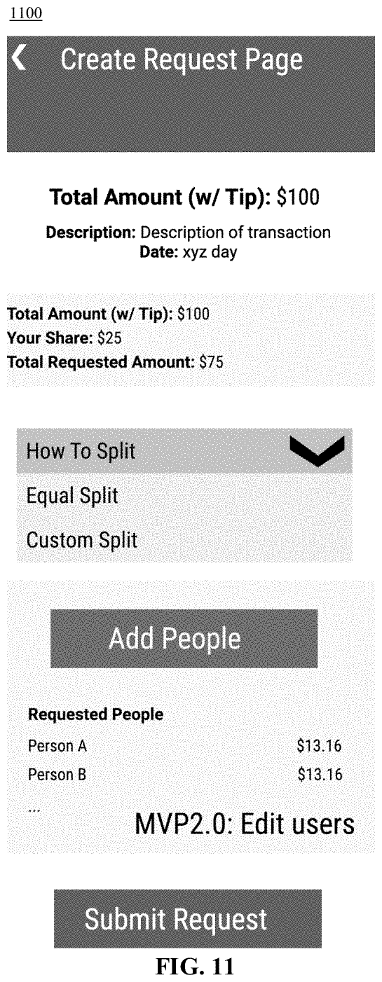

Referring to FIG. 11, a seventh screen shot 1100 includes a heading labeled “Create Request Page” and includes a drop-down menu labeled “How To Split” that includes at least two clickable options, “Equal Split” and “Custom Split” by which the total amount may be either split equally among the participants or may be split according to a customized division therebetween, respectively. There is also a button labeled “Add People” that enables the user to add participants to the splitting process for executing the transaction, accompanied by a list of previously requested participants and a button for submitting the request.

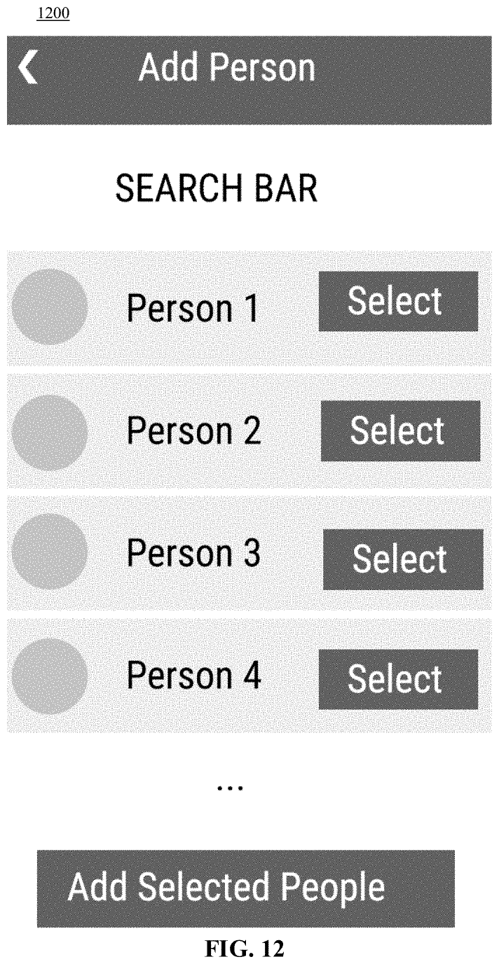

Referring to FIG. 12, an eighth screen shot 1200 is displayed on the user interface in response to the user having clicked on the “Add People” button shown in FIG. 11, and includes a “Search Bar” that enables the user to select from a list of persons. A button labeled “Add Selected People” enables the user to effectuate the requested addition of transaction participants.

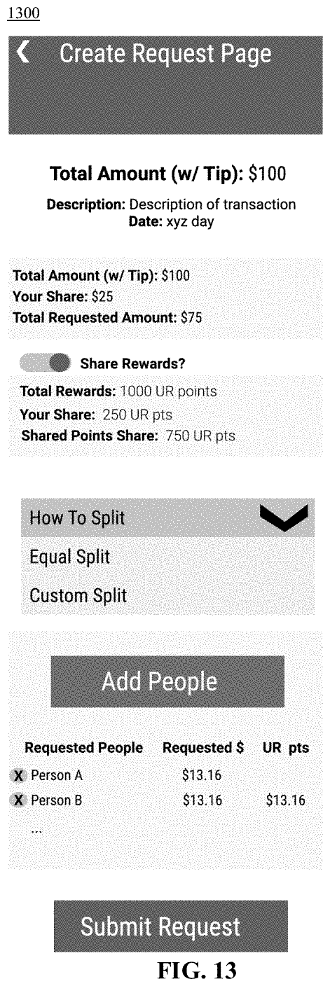

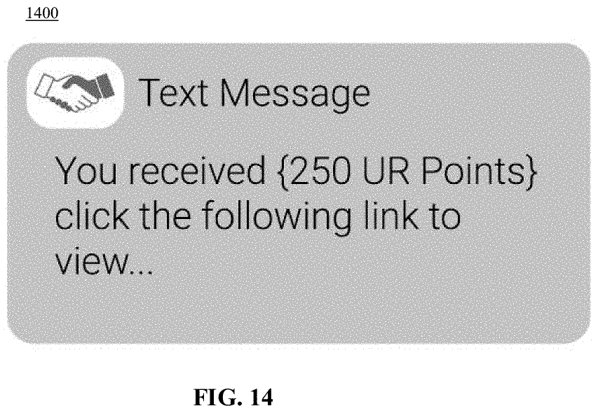

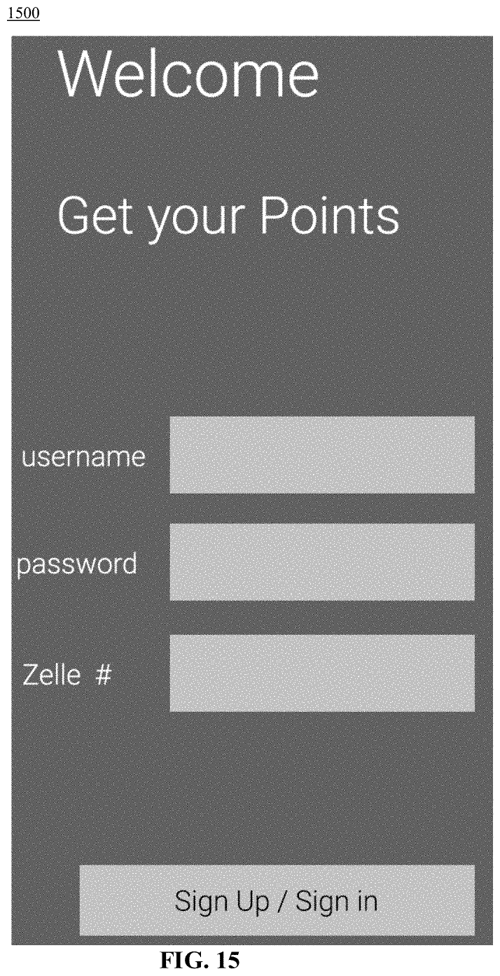

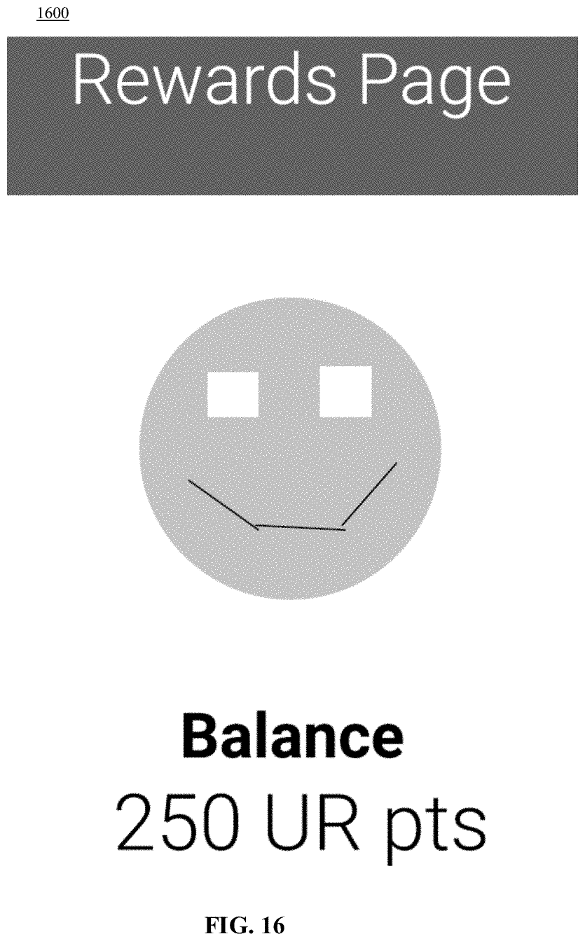

Referring to FIG. 13, a ninth screen shot 1300 is a modified version of the “Create Request Page” shown in FIG. 11. As shown in FIG. 13, the user interface may also display information that relates to sharing rewards among the transaction participants. Referring to FIG. 14, a tenth screen shot 1400 includes a text message that is displayed on the user interface and that indicates an amount of reward points received by the user as a result of the transaction. Referring to FIG. 15, an eleventh screen shot 1500 invites the user to “Get your Points” and prompts the user to enter a username, a password, and a Zelle number by which rewards points may be accessed. Referring to FIG. 16, a twelfth screen shot 1600 includes a “Rewards Page” that is displayed on the user interface and includes a balance of rewards points that are associated with the user's account.

Accordingly, with this technology, an optimized process for tracking a solicitation of contributory payments from multiple parties in connection with a commercial transaction, such as a restaurant bill, by using an application that is trained by using a machine learning technique is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for tracking a solicitation of contributory payments from multiple parties in connection with a single transaction, the method being implemented by at least one processor, the method comprising:
receiving, by the at least one processor, a notification that the single transaction has been executed by a user;
obtaining, by the at least one processor, first information that relates to the transaction;
generating, by the at least one processor based on the first information, a recommendation for soliciting contributions from a plurality of potential participants with respect to the transaction;
transmitting, by the at least one processor to the user, the recommendation;
receiving, by the at least one processor from the user, second information that relates to the plurality of potential participants; and
receiving, by the at least one processor, a confirmation of the recommendation.

2. The method of claim 1, wherein the first information includes at least one from among a total payment amount of the transaction and an identification of a merchant that relates to the transaction.

3. The method of claim 2, wherein the second information includes at least one from among a number of potential participants, an identification of at least one of the potential participants, and an instruction that relates to a respective requested payment amount for each respective one of the potential participants.

4. The method of claim 3, wherein the instruction that relates to the respective requested payment amount includes an indication that each respective requested payment amount is equal.

5. The method of claim 3, wherein the instruction that relates to the respective requested payment amount includes an indication that the respective requested payment amounts are customized so as to vary among the potential participants.

6. The method of claim 2, further comprising:
retrieving historical transaction data that relates to the user;
using the retrieved historical transaction data to train a machine learning algorithm to be used for generating the recommendation; and
generating the recommendation by applying the machine learning algorithm to the received first information.

7. The method of claim 6, wherein when the identification of the merchant includes a restaurant, the generating of the recommendation further comprises using historical information that relates to the restaurant as an input to the machine learning algorithm.

8. The method of claim 7, wherein the historical information that relates to the restaurant includes at least one from among first information that relates to coffee, second information that relates to hamburgers, third information that relates to sandwiches, fourth information that relates to chicken, fifth information that relates to pizza, sixth information that relates to Asian cuisine, seventh information that relates to beverages, eighth information that relates to Mexican cuisine, ninth information that relates to Mediterranean cuisine, tenth information that relates to American cuisine, eleventh information that relates to Brazilian cuisine, and twelfth information that relates to high-end cuisine.

9. The method of claim 8, wherein the historical information that relates to the restaurant further includes at least one Gaussian curve that relates to an expected cost of an outing at the restaurant.

10. A computing apparatus for tracking a solicitation of contributory payments from multiple parties in connection with a single transaction, the computing apparatus comprising:
a processor;
a memory; and
a communication interface coupled to each of the processor and the memory, wherein the processor is configured to:
receive, via the communication interface, a notification that the single transaction has been executed by a user;
obtain first information that relates to the transaction;
generate, based on the first information, a recommendation for soliciting contributions from a plurality of potential participants with respect to the transaction;
transmit, to the user via the communication interface, the recommendation;
receive, from the user via the communication interface, second information that relates to the plurality of potential participants; and
receive, via the communication interface, a confirmation of the recommendation.

11. The computing apparatus of claim 10, wherein the first information includes at least one from among a total payment amount of the transaction and an identification of a merchant that relates to the transaction.

12. The computing apparatus of claim 11, wherein the second information includes at least one from among a number of potential participants, an identification of at least one of the potential participants, and an instruction that relates to a respective requested payment amount for each respective one of the potential participants.

13. The computing apparatus of claim 12, wherein the instruction that relates to the respective requested payment amount includes an indication that each respective requested payment amount is equal.

14. The computing apparatus of claim 12, wherein the instruction that relates to the respective requested payment amount includes an indication that the respective requested payment amounts are customized so as to vary among the potential participants.

15. The computing apparatus of claim 11, wherein the processor is further configured to:
retrieve historical transaction data that relates to the user;
use the retrieved historical transaction data to train a machine learning algorithm to be used for generating the recommendation; and
generate the recommendation by applying the machine learning algorithm to the received first information.

16. The computing apparatus of claim 15, wherein when the identification of the merchant includes a restaurant, the processor is further configured to generate the recommendation by using historical information that relates to the restaurant as an input to the machine learning algorithm.

17. The computing apparatus of claim 16, wherein the historical information that relates to the restaurant includes at least one from among first information that relates to coffee, second information that relates to hamburgers, third information that relates to sandwiches, fourth information that relates to chicken, fifth information that relates to pizza, sixth information that relates to Asian cuisine, seventh information that relates to beverages, eighth information that relates to Mexican cuisine, ninth information that relates to Mediterranean cuisine, tenth information that relates to American cuisine, eleventh information that relates to Brazilian cuisine, and twelfth information that relates to high-end cuisine.

18. The computing apparatus of claim 17, wherein the historical information that relates to the restaurant further includes at least one Gaussian curve that relates to an expected cost of an outing at the restaurant.

19. A non-transitory computer readable storage medium storing instructions for tracking a solicitation of contributory payments from multiple parties in connection with a single transaction, the storage medium comprising executable code which, when executed by a processor, causes the processor to:
receive a notification that the single transaction has been executed by a user;
obtain first information that relates to the transaction;
generate, based on the first information, a recommendation for soliciting contributions from a plurality of potential participants with respect to the transaction;
transmit, to the user, the recommendation;
receive, from the user, second information that relates to the plurality of potential participants; and
receive a confirmation of the recommendation.

20. The storage medium of claim 19, wherein the first information includes at least one from among a total payment amount of the transaction and an identification of a merchant that relates to the transaction.
